(19) United States
(12) Patent Application Publication
(10) Pub. No.: US 2005/0058111 A1
(43) Pub. Date: Mar. 17, 2005

(54) WLAN device having smart antenna system

(76) Inventors: Pai-Fu Hung, Tainan (TW); Ren-Horng You, Tainan (TW)

Correspondence Address: Keith Kline;PRO-TECHTOR INTERNATIONAL SERVICES, 20775 Norada Court, Saratoga, CA, 95070-3018, US

(21) Appl. No.: 10/663,005

(22) Filed: Sep. 15, 2003

(51) Int. Cl. H04Q 7/24

(52) U.S. Cl. 370/338; 370/334

(57) ABSTRACT

A WLAN (Wireless Local Area Network) device having a smart antenna system is disclosed for increasing the number of user under a limited bandwidth and a confined environment. The WLAN device having the smart antenna system comprises: a plurality of WLAN transceiver module; and a plurality of directional antennas or array antennas installed on the WLAN transceiver modules by the way of one-to-one, wherein each of the array antennas is composed of a plurality of omni-directional antenna, such as dipole antennas.

### FIELD OF THE INVENTION

The present invention relates to a WLAN (Wireless Local Area Network) device having a smart antenna system, and more particularly, to the WLAN device which can increase the number of users under the limited bandwidth and space.

### BACKGROUND OF THE INVENTION

With the cost of installing a WLAN getting lower and lower, the WLAN receives more welcome from consumers. With respect to hardware, not only desktop computers and notebook computers have owned built-in wireless network function, but also palm computers and tablet PCs have vigorously provided the support for wireless network. Besides, many public locations including airports, cafes and restaurants, etc. have established hot spots of wireless network.

Generally, a WLAN includes several WLAN cards and an access point. The main function of the access point is to connect a wired network and a wireless network, wherein any personal computer installed a wireless network card can share the resource in the wired network via the access point. Besides, the access point itself also can have the function of network management, thereby performing necessary control on the personal computers.

The access point uses an antenna of a wireless network card to communicate with the users in a cell covered by the antenna. For increasing the number of users, the number of wireless network cards and that of antennas have to be increased. Generally speaking, the number of users is supposed to increase with the number of wireless network cards and that of antennas. For example, two wireless network cards should be able to double the user capacity.

However, co-channel interference occurs among the antennas of the conventional access point, i.e. even if the number of antennas increases, different users cannot use the same frequency towards different antennas, so that the frequencies available to the users are greatly restricted under the limited bandwidth and space. Thus, the number of users fails to increase with the number of antennas installed. Meanwhile, since the conventional access point has various radiation patterns which are frequently overlapped, the position of a user cannot be located via two conventional access points (i.e. the so-called positioning function). The access point listed above is just stated as an example for explanation, and the other WLAN devices such as gateways also have the same shortcomings.

Hence, there is an urgent need to develop a WLAN device having a smart antenna system, thereby enabling the number of users to be increased with the number of antennas installed; and achieving the positioning function via two WLAN devices.

### SUMMARY OF THE INVENTION

An object of the present invention is to provide a WLAN device having a smart antenna system, whereby the number of users can be increased by increasing the number of antennas.

Another object of the present invention is to provide a WLAN device having a smart antenna system, whereby the function of positioning a user can be achieved by two WLAN devices.

Still another object of the present invention is to provide a WLAN device having a smart antenna system, thereby enabling the antennas thereof to have high gains; and obtaining the communication distance increasing exponentially under the condition of the same emitting power as the conventional WLAN device.

According to the aforementioned objects, the present invention provides a WLAN device having a smart antenna system. According to a preferred embodiment of the present invention, the WLAN device having the smart antenna system comprises: a plurality of WLAN transceiver modules and a plurality of directional antennas installed respectively on the WLAN transceiver modules in an one-to-one correspondence, wherein the directional antennas are equally spaced apart in the pattern of annular array, and each of the directional antennas is responsible for the communication among a plurality of users in a cell.

Further, according the other preferred embodiment of the present invention, the WLAN device having the smart antenna system comprises: a plurality of WLAN transceiver modules and a plurality of array antennas installed respectively on the WLAN transceiver modules in an one-to-one correspondence, wherein each of the array antennas is composed of a plurality of omni-directional antennas, and the radiation patterns of the array antennas are controlled to be directional radiation patterns, and each of the array antennas is responsible for the communication among a plurality of users in two cells.

Hence, with the use of the present invention, the number of users can be increased in accordance with the number of antennas, and the position of a user can be located by two WLAN devices, and the communication distance obtained can be increased exponentially under the same condition of emitting power as the conventional WLAN device.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing the operation of a WLAN device having a smart antenna system, according a preferred embodiment of the present invention;

FIG. 2 is a schematic diagram showing the communication among the cells in a WLAN, according the preferred embodiment of the present invention;

FIG. 3 is a schematic diagram showing the operation of a WLAN device having a smart antenna system, according the other preferred embodiment of the present invention; and

FIG. 4 is a schematic diagram showing the structure of an access point using the WLAN device having the smart antenna system according to the present invention.

### DETAILED DESCRIPTION OF THE PREFERRED EMBODIMENT

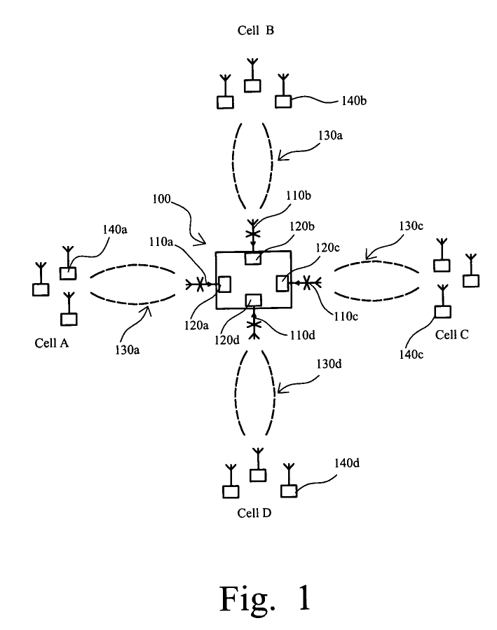

Referring to FIG. 1, FIG. 1 is a schematic diagram showing the operation of a WLAN device having a smart antenna system, according a preferred embodiment of the present invention. According to the present invention, a WLAN device 100 comprises WLAN transceiver modules 120a-d; and directional antennas 110a-d, wherein the directional antennas 110a-d are installed on the WLAN transceiver modules 120a-d respectively, and are equally spaced apart in the pattern of annular array around the WLAN device 100. Since the radiation patterns 130a-d of the directional antennas 110a-d each is concentrated on one single direction, the directional antennas 110a-d are respectively responsible for the communication among a plurality of users 140a-d in cells A-D. Hence, even if the users 140a-d all use one identical frequency for communication, the communication in the cells A-D will not be mutually interfered, i.e. under the limited bandwidth and space, each of the directional antennas can fully take advantage of its bandwidth without being restricted by the co-channel interference occurring among the antennas, and therefore, with increasing one set of directional antenna and WLAN transceiver module, the number of users can be doubled accordingly. Such as shown in FIG. 1, the WLAN device 100 uses four sets of directional antenna and WLAN transceiver module, so that the number of users thereof is increased to be four times as much as that of the device having only one antenna.

The number and locations of the directional antennas and WLAN transceiver modules are merely stated as an example for explanation, and can be increased or decreased in accordance with the actual need. For example, when the WLAN device uses six sets of directional antenna and WLAN transceiver module, those six directional antennas equally spaced apart in the pattern of annular array can be responsible for the communication of six cells respectively, so that the number of users thereof can be increased to be six times as much as that of the device having only one antenna. Further, the WLAN transceiver modules can be such as a WLAN card.

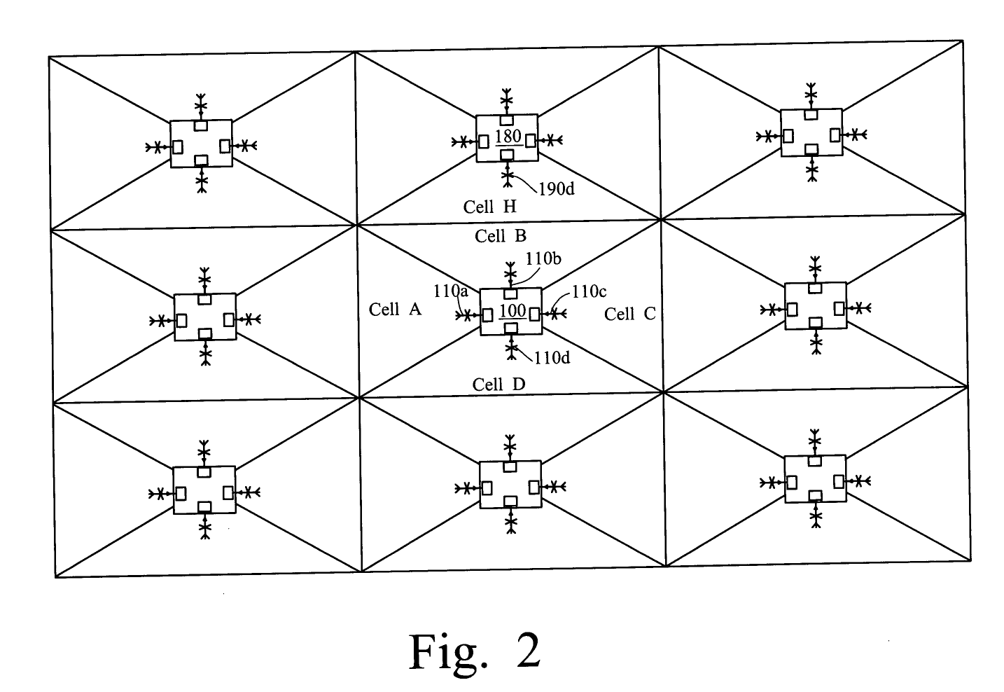

Referring to FIG. 2, FIG. 2 is a schematic diagram showing the communication among the cells in a WLAN, according the preferred embodiment of the present invention. Such as shown in FIG. 2, each of the WLAN devices is responsible for the communication of the surrounding four cells, and the radiation patterns of the antennas thereof are not or nearly not overlapped, so that, when a user crosses over to cell H from cell B, the process of handover can be handled quite easily. Also, by means of the directional antenna 190d in the WLAN device 180 and the directional antenna 110b in the WLAN device 100, when a user crosses over to cell H from cell B, the user can be located, thereby achieving the function of positioning.

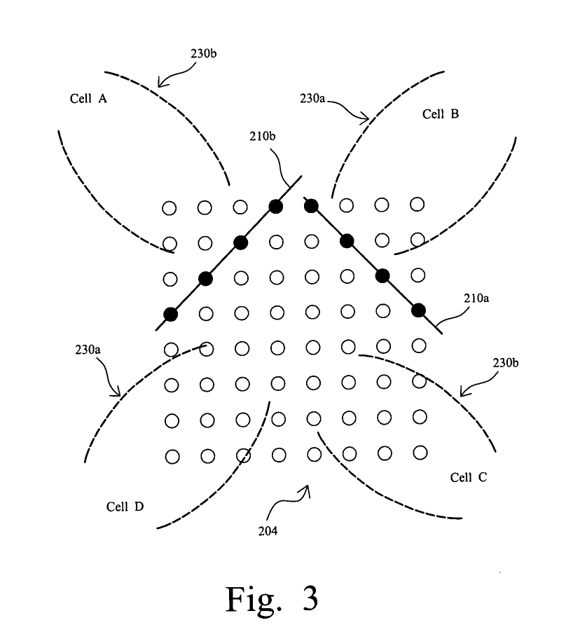

Further, referring to FIG. 3, FIG. 3 is a schematic diagram showing the operation of a WLAN device having a smart antenna system, according the other preferred embodiment of the present invention. The smart antenna system of the present invention also can be composed of array antennas 210a and 210b installed on WLAN transceiver modules, wherein the array antenna 210a (or 210b) is composed of a plurality of omni-directional antennas (such as dipole antennas), and the omni-directional antennas are selected from a omni-directional antenna group 204. The radiation patterns of the array antennas are controlled to be directional radiation patterns, thereby enabling the array antenna 210a to be responsible for the communication of a plurality of users in the opposite cells B and D; and enabling the array antenna 210b to be responsible for the communication of a plurality of users in the opposite cells A and C. Since the radiation pattern 230a of the array antenna 210a is not interfered by the radiation pattern 230b of the array antenna 210b, the users in the cell A (or cell C) can use the same frequency as the users in the cell B (cell D). Therefore, with the use of two sets of array antenna and WLAN transceiver module, the number of users can be doubled.

The number and locations of the array antennas are merely stated as an example for explanation, and the number of the array antennas can be changed in accordance with the actual need, so that the present invention is not limited thereto.

It is worthy to be noted that the present invention is suitable for use in any WLAN devices, such as an access point, a gateway, a wireless switch, a wireless hub, a wireless switching hub and a wireless switching router, etc. Hereinafter, only the structure of an access point is described for explanation:

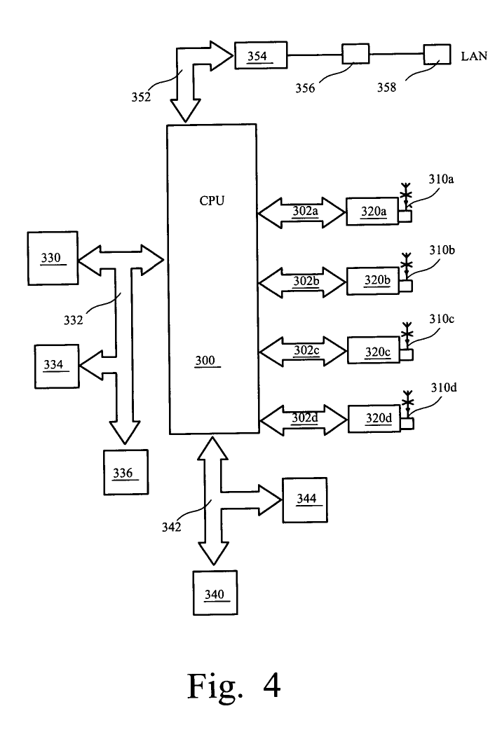

Referring FIG. 4, FIG. 4 is a schematic diagram showing the structure of an access point using the WLAN device having the smart antenna system according to the present invention. The access point comprises: a CPU 300; smart antennas 310a-d respectively installed on WLAN transceiver modules 320a-d; SDRAM 330; flash memory 334; a COM port 336; a reset/watchdog IC 344 and its LED 340; and a RJ-45 connection device 358.

The CPU 300 is connected to the WLAN transceiver modules 320a-d via interface elements 302a-d, and the WLAN transceiver modules 320a-d can use the technical standards such as IEEE802.11a, IEEE802.11b, IEEE802.11g or any arbitrary combination thereof. The interface elements 302a-d can be such as PCI (Peripheral Component Interface), mini PCI, PCMCIA (Personal Computer Memory Card International Association) or Cardbus interfaces, etc. The smart antennas 310a-d can be the antennas as shown in FIG. 1 or FIG. 2.

The CPU 300 is connected to the SDRAM 330, the flash memory 334 and the COM port via a system bus 332. The CPU 300 is connected to the reset/watchdog IC 344 and its LED 340 via a GPIO 342. Further, the CPU 300 is first connected to MAC (Medium Access Control)/PHY (Physical Layer) 354 via a RJ-45 interface 353 (such as PCI or mini PCI), and then is connected to the RJ-45 connection device 358 via a magnetic component (such as a transformer) 356, so as to be connected to a LAN.

From the preferred embodiments described above, it can be known that the application of the present invention has the advantages of: increasing the number of the users in accordance with the number of antennas; having the positioning function and the antennas thereof having high gain, thus obtaining the communication distance increasing exponentially under the same condition of emitting power as the conventional WLAN device.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

1. A WLAN (Wireless Local Area Network) device having a smart antenna system, comprising:
a plurality of WLAN transceiver modules; and
a plurality of directional antennas, respectively installed on said WLAN transceiver modules in an one-to-one correspondence, wherein said directional antennas are equally spaced apart in an annular array, and each of said directional antennas is responsible for the communication of a plurality of users in a cell.

2. The WLAN device having the smart antenna system according to claim 1, wherein the specification of each of said WLAN transceiver modules is selected from a group consisting of IEEE802.11a, IEEE802.11b, IEEE802.11g and an arbitrary combination thereof.

3. The WLAN device having the smart antenna system according to claim 1, wherein said WLAN device is selected from a group consisting of an access point, a gateway, a wireless switch, a wireless hub, a wireless switching hub and a wireless switching router.

4. The WLAN device having the smart antenna system according to claim 1, comprising a CPU.

5. The WLAN device having the smart antenna system according to claim 4, comprising a plurality of interface elements used for respectively connecting said CPU to said WLAN transceiver modules.

6. The WLAN device having the smart antenna system according to claim 5, wherein each of said interface elements is selected from a group consisting of a PCI (Peripheral Component Interface), a mini PCI, PCMCIA (Personal Computer Memory Card International Association) and a Cardbus interface.

7. A WLAN device having a smart antenna system, comprising:
a plurality of WLAN transceiver modules; and
a plurality of array antennas, respectively installed on said WLAN transceiver modules in an one-to-one correspondence, wherein each of said array antennas is composed of a plurality of omni-directional antennas, and the radiation patterns of said array antennas are controlled to be directional radiation patterns, and each of said array antennas is responsible for the communication of a plurality of users in two opposite cells.

8. The WLAN device having the smart antenna system according to claim 7, wherein said omni-directional antennas are a plurality of dipole antennas.

9. The WLAN device having the smart antenna system according to claim 7, wherein the specification of each of said WLAN transceiver modules is selected from a group consisting of IEEE802.11a, IEEE802.11b, IEEE802.11g and an arbitrary combination thereof.

10. The WLAN device having the smart antenna system according to claim 7, wherein said WLAN device is selected from a group consisting of an access point, a gateway, a wireless switch, a wireless hub, a wireless switching hub and a wireless switching router.

11. The WLAN device having the smart antenna system according to claim 7, comprising a CPU.

12. The WLAN device having the smart antenna system according to claim 11, comprising a plurality of interface elements used for respectively connecting said CPU to said WLAN transceiver modules.

13. The WLAN device having the smart antenna system according to claim 12, wherein each of said interface elements is selected from a group consisting of a PCI (Peripheral Component Interface), a mini PCI, PCMCIA (Personal Computer Memory Card International Association) and a Cardbus interface.

14. A smart antenna system, comprising:
a plurality of directional antennas, respectively installed on a plurality of WLAN transceiver modules in an one-to-one correspondence, wherein said directional antennas are equally spaced apart in an annular array, and each of said directional antennas is responsible for the communication of a plurality of users in a cell.

15. The WLAN device having the smart antenna system according to claim 14 wherein the specification of each of said WLAN transceiver modules is selected from a group consisting of IEEE802.11a, IEEE802.11b, IEEE802.11g and an arbitrary combination thereof.

16. The WLAN device having the smart antenna system according to claim 14, suitable for use in a WLAN device, wherein said WLAN device is selected from a group consisting of an access point, a gateway, a wireless switch, a wireless hub, a wireless switching hub and a wireless switching router.

17. The WLAN device having the smart antenna system according to claim 16, wherein said WLAN device comprises a CPU.

18. The WLAN device having the smart antenna system according to claim 17, wherein said WLAN device comprises a plurality of interface elements used for respectively connecting said CPU to said WLAN transceiver modules.
